(19) United States
(12) Patent Application Publication
(10) Pub. No.: US 2016/0283458 A1
(43) Pub. Date: Sep. 29, 2016

(54) INPUT ASSISTANCE SYSTEM, INPUT ASSISTANCE METHOD, AND INPUT ASSISTANCE PROGRAM

(71) Applicant: NEC SOLUTION INNOVATORS, LTD., Tokyo (JP)

(72) Inventors: Yuzuru OKAJIMA, Tokyo (JP); Kosuke YAMAMOTO, Tokyo (JP)

(73) Assignee: NEC SOLUTION INNOVATORS, LTD., Tokyo (JP)

(21) Appl. No.: 14/778,261

(22) PCT Filed: Jan. 10, 2014
(86) PCT No.: PCT/JP2014/000083

§ 371 Date: Sep. 18, 2015

(30) Foreign Application Priority Data
Mar. 18, 2013 (JP) 2013-054954

(51) Int. Cl. G06F 17/24; G06F 3/0482; G06F 17/27

(52) U.S. Cl. CPC G06F 17/243; G06F 17/276; G06F 3/0482

(57) ABSTRACT

An input candidate storage unit stores input candidates for an input box in association with related information of the input candidates. An input candidate selection unit selects input candidates including input characters as recommended candidates out of the input candidates corresponding to the input box upon input of the characters into the input box. A related information extraction unit extracts one or more related information candidates corresponding to the selected recommended candidates out of the related information stored in the input candidate storage unit. A context information acquisition unit acquires context information. A related information determination unit determines related information of the recommended candidates out of the related information candidates by using the character string included in the context information. A recommended information display unit displays the determined related information along with the recommended candidates in the input box or near the input box.

### TECHNICAL FIELD

The present invention relates to an input assistance system, an input assistance method, and an input assistance program for assisting a user in input to an input box.

### BACKGROUND ART

There have been suggested various methods of assisting a user in input to an input box. Patent Literature (PTL) 1 discloses a method of displaying item numbers that coincide with a part of an item number having been input and are set frequently as candidates upon input of the part of the item number.

Moreover, Non Patent Literature (NPL) 1 discloses an input assistance method of assisting an input into an input form having a plurality of input items. In the method disclosed in NPL 1, one is selected out of the plurality of input forms and, upon double-clicking the selected input form, previously-registered recommended candidates are displayed in the input form. Then, upon selection out of the displayed recommended candidates, previously-registered input contents of other input forms are displayed at a time.

### CITATION LIST

### Patent Literature

PTL 1: Japanese Patent Application Laid-Open No. 2000-309407

### Non Patent Literature

NPL 1: IMPRESS BUSINESS MEDIA, “Web Tantousha (Directors) Forum,” [online], [searched on Feb. 13, 2013], Internet <URL: http://web-tan.forum.impressrd.jp/e/2012/04/03/12488>

### SUMMARY OF INVENTION

### Technical Problem

The use of the method disclosed in PTL 1 reduces the number of characters input to each input box. In the method disclosed in PTL 1, however, contents set frequently are fixedly selected. Therefore, the selected content is likely to be not always appropriate for a user.

Meanwhile, in the method disclosed in NPL 1, previously-registered recommended candidates and information related to the recommended candidates are displayed at a time when the selected input form is double-clicked. For example, in the case of input to an input box for a name, e-mail addresses are previously bound, as related information of the name, to recommended candidates, by which the e-mail addresses are displayed as related information along with the names as the recommended candidates. Thereby, a user is able to easily select an intended candidate out of the recommended candidates advantageously.

In the method disclosed in NPL 1, however, the related information displayed along with the recommended candidates is fixedly provided. Therefore, the method is sometimes indecisive for a user to select appropriate information out of the recommended candidates.

Therefore, an object of the present invention is to provide an input assistance system, an input assistance method, and an input assistance program enabling a user to select an appropriate candidate out of recommended candidates in the case where the recommended candidates for an input box are presented to the user.

### Solution to Problem

According to an aspect of the present invention, there is provided an input assistance system including: an input candidate storage unit which stores input candidates for an input box displayed by an input device accepting a user's input in association with related information of the input candidates; an input candidate selection unit which selects input candidates including input characters as recommended candidates out of the input candidates corresponding to the input box upon input of the characters into the input box; a related information extraction unit which extracts one or more related information candidates corresponding to the selected recommended candidates out of the related information stored in the input candidate storage unit; a context information acquisition unit which acquires context information including a character string already input or displayed in connection with the input box; a related information determination unit which determines related information of the recommended candidates out of the related information candidates by using the character string included in the context information; and a recommended information display unit which displays the determined related information along with the recommended candidates in the input box or near the input box.

According to another aspect of the present invention, there is provided an input assistance method including: referring to an input candidate storage unit storing input candidates for an input box displayed by an input device accepting a user's input in association with related information of the input candidates and selecting input candidates including input characters as recommended candidates out of the input candidates corresponding to the input box upon input of the characters into the input box; extracting one or more related information candidates corresponding to the selected recommended candidates out of the related information stored in the input candidate storage unit; acquiring context information including a character string already input or displayed in connection with the input box; determining related information of the recommended candidates out of the related information candidates by using the character string included in the context information; and displaying the determined related information along with the recommended candidates in the input box or near the input box.

According to still another aspect of the present invention, there is provided an input assistance program causing a computer to perform: an input candidate selection process of referring to an input candidate storage unit storing input candidates for an input box displayed by an input device accepting a user's input in association with related information of the input candidates and selecting input candidates including input characters as recommended candidates out of the input candidates corresponding to the input box upon input of the characters into the input box; a related information extraction process of extracting one or more related information candidates corresponding to the selected recommended candidates out of the related information stored in the input candidate storage unit; a context information acquisition process of acquiring context information including a character string already input or displayed in connection with the input box; a related information determination process of determining related information of the recommended candidates out of the related information candidates by using the character string included in the context information; and a recommended information display process of displaying the determined related information along with the recommended candidates in the input box or near the input box.

### Advantageous Effects of Invention

According to the present invention, a user is able to select an appropriate candidate out of recommended candidates in the case where the recommended candidates for an input box are presented to the user.

### BRIEF DESCRIPTION OF DRAWINGS

FIG. 1 It depicts a block diagram illustrating a configuration example of a first exemplary embodiment of an input assistance system according to the present invention.

FIG. 2 It depicts an explanatory diagram illustrating an example of information stored in an input candidate storage unit 10.

FIG. 3 It depicts an explanatory diagram illustrating an example of information stored in an input log storage unit 70.

FIG. 4 It depicts an explanatory diagram illustrating an example of an input box displayed by an input-output device 100.

FIG. 5 It depicts a block diagram illustrating a configuration example of a second exemplary embodiment of an input assistance system according to the present invention.

FIG. 6 It depicts an explanatory diagram illustrating an example of an input screen displayed by an input-output device 100.

FIG. 7 It depicts a block diagram illustrating an outline of the input assistance system according to the present invention.

### DESCRIPTION OF EMBODIMENT(S)

Exemplary embodiments of the present invention will be described below with reference to the accompanying drawings.

### Exemplary Embodiment 1

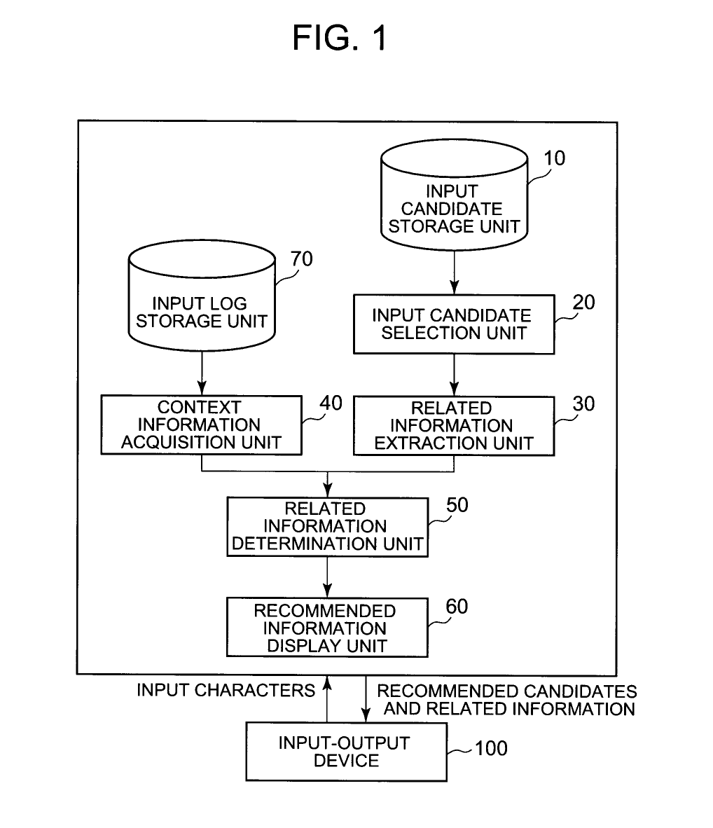

FIG. 1 is a block diagram illustrating a configuration example of a first exemplary embodiment of an input assistance system according to the present invention. The input assistance system of this exemplary embodiment includes an input candidate storage unit 10, an input candidate selection unit 20, a related information extraction unit 30, a context information acquisition unit 40, a related information determination unit 50, a recommended information display unit 60, and an input log storage unit 70.

Moreover, the input-output device 100, which is connected to the input assistance system, transmits characters input from a user to the input assistance system and outputs information determined by the input assistance system. More specifically, the input-output device 100 displays an input box for accepting an input from the user and transmits the characters input to the input box to the input assistance system. Furthermore, upon receiving the information determined by the input assistance system, the input-output device 100 displays the received information in the corresponding input box.

The input-output device 100 is implemented by, for example, a keyboard, a display device, a touch panel, and the like.

The input candidate storage unit 10 stores an input candidate for an input box in association with information related to the input candidate. The information stored in the input candidate storage unit 10 is an information source for determining a recommended candidate described later. The content of each input candidate is specified by information indicating the content of the input candidate (hereinafter, sometimes referred to as “field information”).

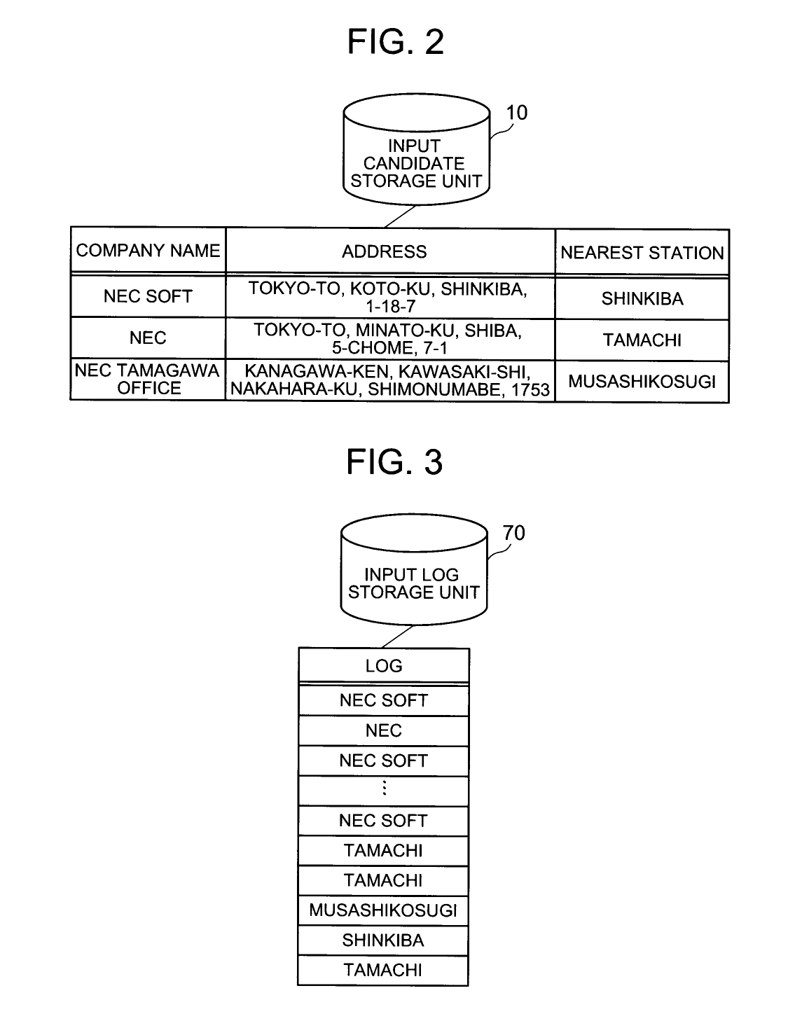

FIG. 2 is an explanatory diagram illustrating an example of information stored in the input candidate storage unit 10. The input candidate storage unit 10 illustrated in FIG. 2 stores a company name, an address, and the nearest station as input candidates and the input candidates are associated with other input candidates as related information thereof. Specifically, the information stored in the input candidate storage unit 10 can be said to be an input candidate for each input box and, at the same time, related information of other input candidates.

In the example illustrated in FIG. 2, there is illustrated an example that the input candidate storage unit 10 stores input candidates and related information in a table format. The storage format, however, is not limited to the table format and may be any other format as long as the input candidates for each input box can be identified by the format.

Upon input of characters into an input box displayed by the input-output device 100, the input candidate selection unit 20 selects input candidates including the input characters as recommended candidates out of the input candidates corresponding to the input box with reference to the input candidate storage unit 10.

Specifically, the input candidate selection unit 20 selects input candidates including input characters when at least some characters are input into the input box. In this process, the input candidate selection unit 20 may select input candidates each of which forward-matches the input characters as recommended candidates or may select input candidates each of which partially matches the input characters as recommended candidates.

The related information extraction unit 30 extracts candidates for related information corresponding to the selected recommended candidates out of the related information stored in the input candidate storage unit 10. The related information extraction unit 30 may extract all related information corresponding to the selected recommended candidates or may extract only related information of predetermined contents. The number of pieces of extracted related information may be either one or two or more.

The input log storage unit 70 stores character strings input in the past to the input-output device 100. The input log storage unit 70 may store all logs input in the past to the input-output device 100. Moreover, the input log storage unit 70 may store an input box where a character string is input, a user having input the character string, a predetermined user group having input the character string, a page where the character string is input, and the like in association with the input character string.

FIG. 3 is an explanatory diagram illustrating an example of information stored in the input log storage unit 70. In the example illustrated in FIG. 3, it is illustrated that only character strings input in the past are stored in the input log storage unit 70. In the explanation described below, a character string stored in the input log storage unit 70 is sometimes referred to as “input log.”

The context information acquisition unit 40 acquires an information source (hereinafter, referred to as “context information”) for determining which related information is to be selected out of the candidates for related information extracted by the related information extraction unit 30. The context information includes a character string already input or displayed in connection with each input box. For example, a character string input in the past to the input-output device 100 which displays the input box, a character string displayed in a page including the input box, and a character string input in any other input box existing in the page including the input box concerned fall under context information.

In this exemplary embodiment, description will be made on a method of using the character string stored in the input log storage unit 70 as context information. Specifically, in this exemplary embodiment, the character string (input log) input in the past to the input-output device 100 is used as context information.

The related information determination unit 50 determines related information of a recommended candidate out of the candidates for the extracted related information by using character strings included in the context information. The related information determination unit 50 may determine only one piece of related information or may determine a plurality of pieces of related information.

Specifically, the related information determination unit 50 searches for character strings completely matching the related information extracted by the related information extraction unit 30 out of the character strings stored in the input log storage unit 70 and identifies the number of character strings completely matching the related information. Then, the related information determination unit 50 determines the related information completely matching the largest number of character strings for each recommended candidate as related information of each recommended candidate.

Additionally, the related information determination unit 50 may determine not only the related information completely matching the largest number of character strings, but also related information completely matching the character strings of the top n in the largest number thereof as the related information of each recommended candidate. Moreover, the related information determination unit 50 may determine the related information where the ratio of the number of character strings completely matching the related information is a predetermined threshold value or more as the related information of each recommended candidate.

Moreover, although description has been made in this exemplary embodiment on a method in which the related information determination unit 50 determines related information of each recommended candidate by totalizing the number of input logs completely matching the related information, the totalizing method is not limited to the above method. The related information determination unit 50 may totalize, for example, the number of character strings determined to be similar in the similarity search. In addition, the related information determination unit 50 may determine two character strings between which an edit distance is a predetermined distance a or less, if so, to be identical character strings and totalize the number of character strings determined to be identical.

The recommended information display unit 60 displays the determined related information along with the recommended candidates. More specifically, the recommended information display unit 60 displays the recommended candidates selected by the input candidate selection unit 20 and the related information determined by the related information determination unit 50 out of the related information of the recommended candidates in association with the respective input boxes. The recommended information display unit 60 may display the recommended candidates corresponding to the input box and the related information thereof in the input box or near the input box (for example, in a position adjacent to the input box).

The recommended information display unit 60 may display the recommended information and the related information in different forms. For example, the recommended information display unit 60 may display recommended candidates in black and related information in gray. This enables differentiation between character strings actually input and information as a reference.

Moreover, the recommended information display unit 60 may display the contents of related information along with the related information. For example, if the displayed related information is a company name, the recommended information display unit 60 may display the related information with heading indicating the content “Company name:” added thereto. This clarifies the content of the displayed related information, thereby enabling the user to select the recommended candidate more easily.

Furthermore, the recommended information display unit 60 may display only one piece of related information or may display a plurality of pieces of related information. For example, if a plurality of pieces of related information is displayed, the recommended information display unit 60 may display the related information in the input direction (for example, from the left side) in the descending order of frequency of input in the past. In addition, the recommended information display unit 60 may display related information within the range where displaying in the input box is possible.

The input candidate selection unit 20, the related information extraction unit 30, the context information acquisition unit 40, the related information determination unit 50, and the information display unit 60 are implemented by the CPU of a computer which operates according to a program (input assistance program). For example, the program is stored in a storage unit (not illustrated) of a device constituting the input assistance system, and the CPU may read the program to operate as the input candidate selection unit 20, the related information extraction unit 30, the context information acquisition unit 40, the related information determination unit 50, and the recommended information display unit 60 according to the program.

Furthermore, each of the input candidate selection unit 20, the related information extraction unit 30, the context information acquisition unit 40, the related information determination unit 50, and the recommended information display unit 60 may be implemented by dedicated hardware.

Moreover, the input candidate storage unit 10 and the input log storage unit 70 are implemented by, for example, a magnetic disk and the like.

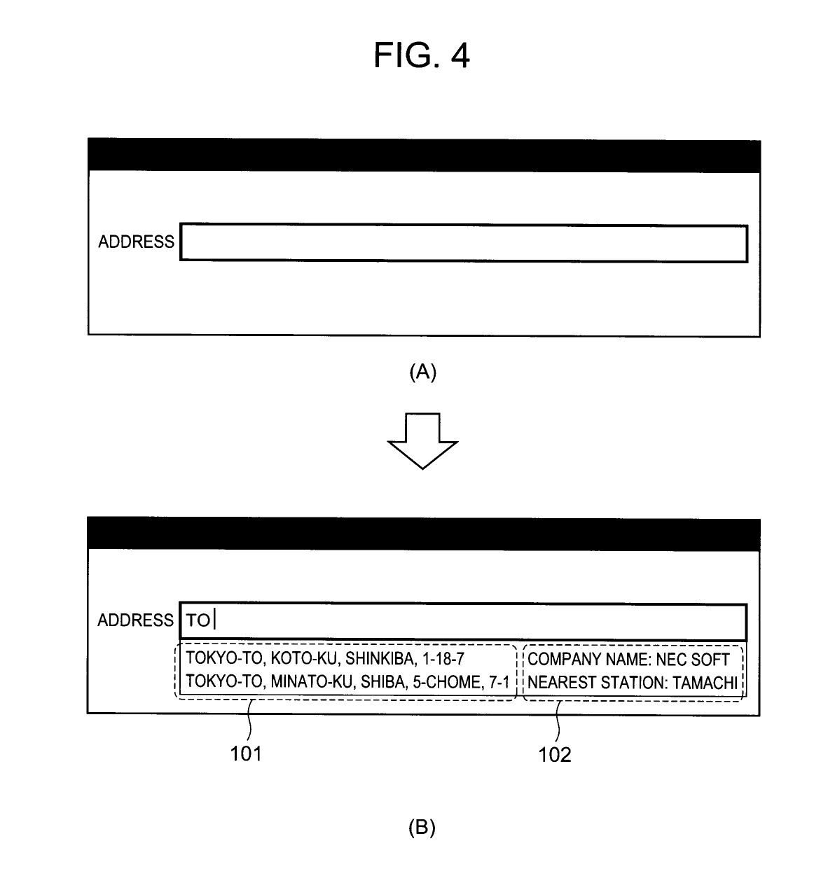

Subsequently, the operation of this exemplary embodiment will be described concretely by using FIGS. 2, 3, and 4. FIG. 4 is an explanatory diagram illustrating an example of an input box displayed by an input-output device 100. It is assumed that an address is input to the input box illustrated in FIG. 4(A) and that the “address” field stored in the input candidate storage unit 10 corresponds to input candidates for the input box.

First, the input candidate selection unit 20 determines recommended candidates for the input box out of the input candidates stored in the input candidate storage unit 10 on the basis of the input character information. The input candidate selection unit 20 may determine the recommended candidates, for example, by performing forward matching search for the input character string.

For example, as illustrated in FIG. 4(B), it is assumed that “To” is input to the input box. In this case, two recommended candidates, “Tokyo-to, Koto-ku, Shinkiba, 1-18-7” and “Tokyo-to, Minato-ku, Shiba, 5-chome, 7-1” are determined out of the “address” column illustrated in FIG. 2.

Subsequently, the related information extraction unit 30 extracts information bound to each recommended candidate (the company name and the nearest station bound to the address in the example illustrated in FIG. 2). In the example illustrated in FIG. 2, “NEC Soft” and “Shinkiba” are extracted based on the recommended candidate “Tokyo-to, Koto-ku, Shinkiba, 1-18-7” and “NEC” and “Tamachi” are extracted based on the recommended candidate “Tokyo-to, Minato-ku, Shiba, 5-chome, 7-1.”

Subsequently, the context information acquisition unit 40 acquires an input log from the input log storage unit 70. The related information determination unit 50 collates the information extracted by the related information extraction unit 30 with the input log and determines the related information appearing most frequently as the related information of the recommended candidate among the recommended candidates.

In the example illustrated in FIG. 3, the input logs include three “NEC Soft” logs and one “Shinkiba” log. Therefore, the related information determination unit 50 determines “NEC Soft” as the related information of the recommended candidate “Tokyo-to, Koto-ku, Shinkiba, 1-18-7.” Similarly, in the example illustrated in FIG. 3, the input logs include one “NEC” log and three “Tamachi” logs. Therefore, the related information determination unit 50 determines “Tamachi” as the related information of the recommended candidate Tokyo-to, Minato-ku, Shiba, 5-chome, 7-1.”

The recommended information display unit 60 displays the determined related information along with the recommended candidates. In the example illustrated in FIG. 4(B), it is illustrated that the recommended information display unit 60 displays the respective recommended candidates 101 and the related information 102 with information indicating the contents of the related information added thereto.

As described hereinabove, according to this exemplary embodiment, upon input of characters into the input box, the input candidate selection unit 20 selects input candidates including the input characters as recommended candidates out of the input candidates corresponding to the input box stored in the input candidate storage unit 10. Moreover, the related information extraction unit 30 extracts one or more pieces of related information corresponding to the selected recommended candidates from the related information stored in the input candidate storage unit 10 and the related information determination unit 50 determines the related information of the recommended candidate by using the character string included in the context information acquired by the context information acquisition unit 40. Then, the recommended information display unit 60 displays the determined related information along with the recommended candidates in the input box (or near the input box).

Therefore, in the case where the recommended candidates for the input box are presented to the user, the user is able to select an appropriate candidate out of the recommended candidates.

Specifically, if the user is very experienced in inputting the information concerned, the user is highly likely to remember the information. In the input assistance system according to this exemplary embodiment, outputting the information as related information provides an effect that the user is able to determine which is appropriate among the recommended candidates more easily.

Moreover, although description has been made on a case where the input log storage unit 70 stores only input logs in this exemplary embodiment, the input logs may be stored with information related to the input logs added thereto as described above. The input log storage unit 70 may store, for example, identification information of a user having input a character string (user ID) or identification information of a user group including the user having input the character string (group ID) in association with the character string.

In this case, the input-output device 100 may notify the input assistance system of the user ID or the group ID of the user who inputs the character string, and the context information acquisition unit 40 may acquire the character string associated with the user having input the characters into the input box from the input log storage unit 70 and may use the character string as context information.

Related information is determined with the character string input in the past by the user as a target in this manner, thereby enabling the user to select a more appropriate candidate out of the recommended candidates. Moreover, in the case of a company, users belonging to the same department or to the same project are likely to have sharable background knowledge. Therefore, a user is able to select more appropriate candidate out of the recommended candidates also by determining the related information with the character string input in the past by a specific user group as a target.

### Exemplary Embodiment 2

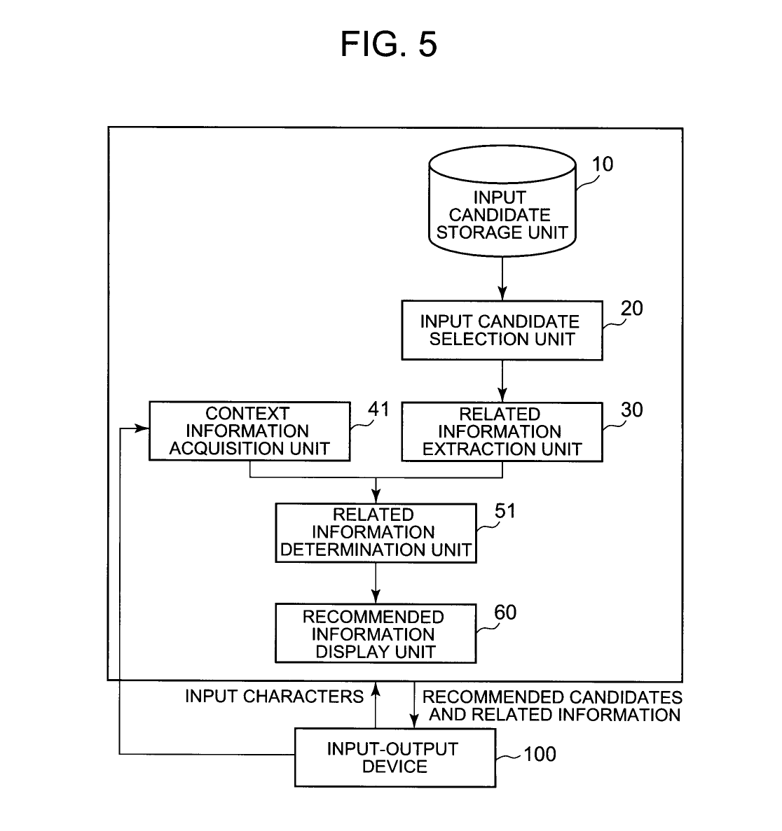

Subsequently, a second exemplary embodiment of the input assistance system according to the present invention will be described below. FIG. 5 is a block diagram illustrating a configuration example of the second exemplary embodiment of the input assistance system according to the present invention. The same reference numerals as those of FIG. 1 are used for the same parts as in the first exemplary embodiment and the description thereof is omitted here.

The input assistance system of this exemplary embodiment includes an input candidate storage unit 10, an input candidate selection unit 20, a related information extraction unit 30, a context information acquisition unit 41, a related information determination unit 51, and a recommended information display unit 60.

The context information acquisition unit 41 acquires context information similarly to the context information acquisition unit 40. The context information acquisition unit 41, however, is different from the context information acquisition unit 40 of the first exemplary embodiment in acquiring context information.

The context information acquisition unit 41 acquires at least one of the character string in the page where the input box is displayed and the character string already input to the input box in the page as context information. The context information acquisition unit 41 may acquire the character string already input to the input box under input as context information. In the description below, the character string in the page where the input box is displayed and the character string already input to the input box in the page are sometimes referred to as “peripheral text.”

Furthermore, the context information acquisition unit 41 may acquire character strings input in the preceding and following input boxes as context information for the input box. The character strings of the adjacent input boxes are acquired as context information in this manner, thereby enabling use of related context information from the input box.

The range in which the context information acquisition unit 41 acquires character strings may be previously determined for each input box.

The related information determination unit 51 determines the related information of a recommended candidate by using a character string included in the context information in the same manner as the related information determination unit 50. Specifically, the related information determination unit 51 specifies a character string completely matching related information included in the candidate for the related information extracted by the related information extraction unit 30 out of the context information acquired by the context information acquisition unit 41. Moreover, the related information determination unit 51 specifies the content of the specified character string from the input candidates stored in the input candidate storage unit 10. Then, the related information determination unit 51 determines the input candidate indicating the content as the related information of each recommended candidate.

For example, if the input candidate storage unit 10 stores input candidates in a table format, the related information determination unit 51 identifies a field including the specified character string out of the input candidates stored in the input candidate storage unit 10 and determines the related information of the field to be the related information of each recommended candidate.

The context information acquisition unit 41 and the related information determination unit 51 are implemented by the CPU of a computer which operates according to a program (input assistance program). Furthermore, each of the context information acquisition unit 41 and the related information determination unit 51 may be implemented by dedicated hardware.

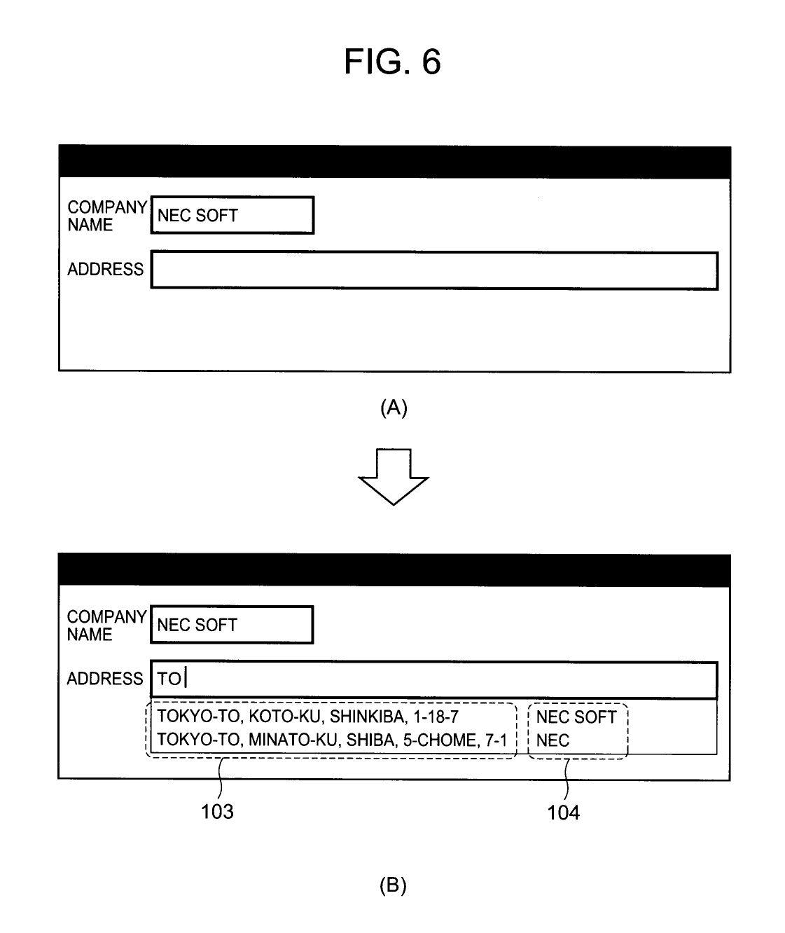

Subsequently, the operation of this exemplary embodiment will be described concretely by using FIGS. 2 and 6. FIG. 6 is an explanatory diagram illustrating an example of an input screen displayed by the input-output device 100. On the input screen illustrated in FIG. 6(A), input boxes for inputting a company name and an address are displayed. It is assumed that “a company name” and “an address” stored in the input candidate storage unit 10 are input candidates for the input boxes.

Furthermore, the context information used for displaying recommended candidates in the input box of the “address” is assumed to be a character string input at the “company name.”

Similarly to the first exemplary embodiment, if “To” is input to the input box, the input candidate selection unit 20 determines two addresses, “Tokyo-to, Koto-ku, Shinkiba, 1-18-7” and “Tokyo-to, Minato-ku, Shiba, 5-chome, 7-1,” as recommended candidates. The related information extraction unit 30 extracts “NEC Soft” and “Shinkiba” as the related information of the former and “NEC” and “Tamachi” as the related information of the latter.

Subsequently, the context information acquisition unit 41 acquires target context information. In the example illustrated in FIG. 6, “NEC Soft” is acquired as context information.

The related information determination unit 51 specifies a character string in the extracted related information matching the acquired context information. In the example illustrated in FIGS. 2 and 6, “NEC Soft” is included in the extracted related information. Therefore, the related information determination unit 51 specifies this character string as the matching character string.

The related information determination unit 51 specifies a field including “NEC Soft” as a character string from the input candidates stored in the input candidate storage unit 10. In the example illustrated in FIG. 2, “NEC Soft” is included in the “company name” field.

Then, the related information determination unit 51 determines the input candidate in the specified field to be the related information of each recommended candidate. In the example illustrated in FIG. 2, the related information determination unit 51 specifies “NEC Soft” stored in the “company name” field as the related information, out of the related information of the recommended candidate “Tokyo-to, Koto-ku, Shinkiba, 1-18-7.” Similarly, the related information determination unit 51 specifies “NEC” stored in the “company name” field as the related information, out of the related information of the recommended candidate “Tokyo-to, Minato-ku, Shiba, 5-chome, 7-1.”

The recommended information display unit 60 displays the determined related information along with the recommended candidates. In the example illustrated in FIG. 6(B), it is illustrated that the recommended information display unit 60 displays the related information 104 along with the recommended candidates 103.

As described hereinabove, according to this exemplary embodiment, the context information acquisition unit 41 acquires at least one of the character string in the page where the input box is displayed and the character string already input to the input box in the page as context information. In addition, the related information determination unit 51 specifies the character string matching the extracted related information out of the acquired context information and specifies the content of the specified character string from the input candidate stored in the input candidate storage unit 10 to determine the input candidate indicating the content to be the related information of each recommended candidate.

Therefore, in the case where recommended candidates for an input box are presented to a user, the user is able to select an appropriate candidate out of the recommended candidates even if input logs are not stored.

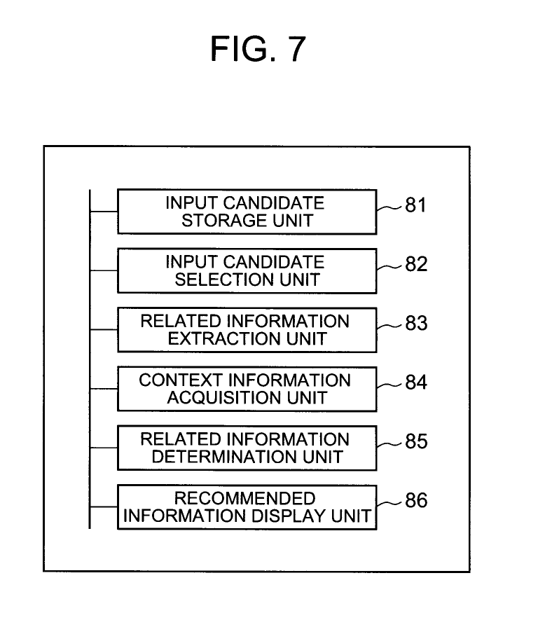

Subsequently, the outline of the present invention will be described. FIG. 7 is a block diagram illustrating an outline of the input assistance system according to the present invention. The input assistance system according to the present invention includes an input candidate storage unit 81 (for example, the input candidate storage unit 10) storing input candidates for an input box displayed by an input device (for example, the input-output device 100) accepting a user's input in association with related information of the input candidates; an input candidate selection unit 82 (for example, the input candidate selection unit 20) selecting input candidates including input characters as recommended candidates out of the input candidates corresponding to the input box upon input of the characters into the input box; a related information extraction unit 83 (for example, the related information extraction unit 30) extracting one or more related information candidates corresponding to the selected recommended candidates out of the related information stored in the input candidate storage unit 81; a context information acquisition unit 84 (for example, the context information acquisition unit 40) acquiring context information (for example, an input log and a peripheral text) including a character string already input or displayed in connection with the input box; a related information determination unit 85 (for example, the related information determination unit 50) determining the related information of the recommended candidates out of the related information candidates by using the character string included in the context information; and a recommended information display unit 86 (for example recommended information display unit 60) displaying the determined related information along with the recommended candidates in the input box or near the input box.

According to the above configuration, a user is able to select an appropriate candidate out of recommended candidates in the case where the recommended candidates for an input box are presented to the user.

Furthermore, the input assistance system may include an input log storage unit (for example, the input log storage unit 70) storing a character string input into the input device. In addition, the context information acquisition unit 84 may acquire a character string stored in the input log storage unit as context information.

According to the configuration, the character strings input in the past can be taken into consideration, thereby enabling the display of preferable related information for the user to select an appropriate candidate.

Furthermore, the input log storage unit may store at least one of identification information of a user having input a character string (for example, a user ID) and identification information of a user group including the user having input the character string (for example, a group ID) in association with the character string. Additionally, the context information acquisition unit 84 may acquire a character string associated with the user having input the characters into the input box from the input log storage unit and may use the character string as context information.

According to the above configuration, the user is able to acquire context information by focusing on the information input in the past by the user out of the character strings input to the input device, thereby enabling the display of more preferable related information for the user to select an appropriate candidate.

Meanwhile, the context information acquisition unit 84 (for example, the context information acquisition unit 41) may acquire at least one (for example, a peripheral text) of the character string in the page where the input box is displayed and the character string already input to the input box in the page as context information. In addition, the related information determination unit 85 (for example, the related information determination unit 51) may specify a character string matching the related information included in the related information candidates out of the acquired context information and specify the content of the specified character string from the input candidate stored in the input candidate storage unit 81 to determine the input candidate indicating the content to be the related information of each recommended candidate.

According to the above configuration, in the case where recommended candidates for an input box are presented to a user, the user is able to select an appropriate candidate out of the recommended candidates even if input logs are not stored.

Moreover, the recommended information display unit 86 may display information indicating the content of related information along with the related information. According to the configuration, the content indicated by the related information is clarified, thereby enabling the user to select a recommended candidate more easily.

Although the present invention has been described with reference to the exemplary embodiments and examples hereinabove, the present invention is not limited thereto. A variety of changes, which can be understood by those skilled in the art, may be made in the configuration and details of the present invention within the scope thereof.

This application claims priority to Japanese Patent Application No. 2013-054954 filed on Mar. 18, 2013, and the entire disclosure thereof is hereby incorporated herein by reference.

### INDUSTRIAL APPLICABILITY

The present invention is preferably applied to the input assistance system for assisting a user in input to an input box.

### REFERENCE SIGNS LIST

10 Input candidate storage unit
20 Input candidate selection unit
30 Related information extraction unit
40, 41 Context information acquisition unit
50, 51 Related information determination unit
60 Recommended information display unit
70 Input log storage unit
100 Input-output device

1. An input assistance system including:
an input candidate storage unit which stores input candidates for an input box displayed by an input device accepting a user's input in association with related information of the input candidates;
an input candidate selection unit which selects input candidates including input characters as recommended candidates out of the input candidates corresponding to the input box upon input of the characters into the input box;
a related information extraction unit which extracts one or more related information candidates corresponding to the selected recommended candidates out of the related information stored in the input candidate storage unit;
a context information acquisition unit which acquires context information including a character string already input or displayed in connection with the input box;
a related information determination unit which determines related information of the recommended candidates out of the related information candidates by using the character string included in the context information; and
a recommended information display unit which displays the determined related information along with the recommended candidates in the input box or near the input box.

2. The input assistance system according to claim 1, further including an input log storage unit which stores the character string input to the input device, wherein the context information acquisition unit acquires the character string stored in the input log storage unit as context information.

3. The input assistance system according to claim 2, wherein:
the input log storage unit stores at least one of identification information of a user having input the character string and identification information of a user group including the user having input the character string in association with the character string; and
the context information acquisition unit acquires the character string associated with the user having input the characters into the input box from the input log storage unit and uses the character string as context information.

4. The input assistance system according to claim 1, wherein:
the context information acquisition unit acquires at least one of a character string in a page where the input box is displayed and a character string already input to the input box in the page as context information; and
the related information determination unit specifies a character string matching related information included in the related information candidates out of the acquired context information and specifies the content of the specified character string from the input candidate stored in the input candidate storage unit to determine the input candidate indicating the content to be the related information of each recommended candidate.

5. The input assistance system according to claim 1, wherein the recommended information display unit displays information indicating the content of the related information along with the related information.

6. An input assistance method including:
referring to an input candidate storage unit storing input candidates for an input box displayed by an input device accepting a user's input in association with related information of the input candidates and selecting input candidates including input characters as recommended candidates out of the input candidates corresponding to the input box upon input of the characters into the input box;
extracting one or more related information candidates corresponding to the selected recommended candidates out of the related information stored in the input candidate storage unit;
acquiring context information including a character string already input or displayed in connection with the input box;
determining related information of the recommended candidates out of the related information candidates by using the character string included in the context information; and
displaying the determined related information along with the recommended candidates in the input box or near the input box.

7. The input assistance method according to claim 6, wherein the character string stored in an input log storage unit storing the character string input to an input device is acquired as context information.

8. The input assistance method according to claim 6, wherein at least one of a character string in a page where the input box is displayed and a character string already input to the input box in the page is acquired as context information.

9. A non-transitory computer readable information recording medium storing an input assistance program, when executed by a processor, that performs a method for:
referring to an input candidate storage unit storing input candidates for an input box displayed by an input device accepting a user's input in association with related information of the input candidates and selecting input candidates including input characters as recommended candidates out of the input candidates corresponding to the input box upon input of the characters into the input box;
extracting one or more related information candidates corresponding to the selected recommended candidates out of the related information stored in the input candidate storage unit;
acquiring context information including a character string already input or displayed in connection with the input box;
determining related information of the recommended candidates out of the related information candidates by using the character string included in the context information; and
displaying the determined related information along with the recommended candidates in the input box or near the input box.

10. The non-transitory computer readable information recording medium according to claim 9, wherein the character string stored in an input log storage unit storing the character string input to an input device is acquired as context information.

11. The non-transitory computer readable information recording medium according to claim 9, wherein at least one of a character string in a page where the input box is displayed and a character string already input to the input box in the page is acquired as context information.

12. The input assistance system according to claim 2, wherein the recommended information display unit displays information indicating the content of the related information along with the related information.

13. The input assistance system according to claim 3, wherein the recommended information display unit displays information indicating the content of the related information along with the related information.

14. The input assistance system according to claim 4, wherein the recommended information display unit displays information indicating the content of the related information along with the related information.
